(19) United States
(12) Patent Application Publication
(10) Pub. No.: US 2025/0145414 A1
(43) Pub. Date: May 8, 2025

(54) ELEVATOR DEVICE

(71) Applicant: Hitachi, Ltd., Tokyo (JP)

(72) Inventors: Yasuhiro KANAYAMA, Tokyo (JP); Hironori KANETA, Tokyo (JP); Koto NAKAGAWA, Tokyo (JP); Yusuke MURATA, Tokyo (JP)

(21) Appl. No.: 18/835,746

(22) PCT Filed: Mar. 25, 2022
(86) PCT No.: PCT/JP2022/014539

§ 371 Date: Aug. 5, 2024

(51) Int. Cl. B66B 11/00; B66B 1/34; B66B 5/04

(52) U.S. Cl. CPC B66B 11/002; B66B 1/34; B66B 5/04; B66B 11/0045

(57) ABSTRACT

An elevator device includes a car, a hoisting machine, and a control panel that controls operation. The control panel has a regenerative resistance panel part, a main circuit panel part, a power receiving panel part, a signal panel part, and a battery panel part. The main circuit panel part and the power receiving panel part are arranged in parallel in a horizontal direction. The regenerative resistance panel part, the main circuit panel part and power receiving panel part, the signal panel part, and the battery panel part are arranged in an order of, from top to bottom, the regenerative resistance panel part, the main circuit panel part and power receiving panel part, the signal panel part, and the battery panel part.

### TECHNICAL FIELD

The present invention relates to an elevator device, and more particularly to the configuration of a control panel used in the elevator device.

### BACKGROUND ART

Conventionally, there has been known a machine room-less elevator device in which there is no machine room where a hoisting machine is disposed, and in which the hoisting machine is disposed within a hoistway. Patent Literature 1 discloses a machine room-less elevator device having a normal control panel (hereinafter referred to as the control panel) disposed on the inner wall surface at the top of the hoistway. The control panel has a vertically long structure extending in the vertical direction (see paragraph 0027 and FIG. 4).

### CITATION LIST

### Patent Literature

Patent Literature 1: Japanese Unexamined Patent Application Publication No. 2018-52648

### SUMMARY OF INVENTION

### Technical Problem

In the case of a control panel having a vertically long structure, such as the control panel in Patent Literature 1, the entire area from the top end to the bottom end may not fit within the range (hereinafter referred to as the overhead dimension: OH dimension) between the floor level of the top floor and the ceiling level of the hoistway. In this case, the lower part of the control panel is located below the ceiling of a car (hereinafter referred to as “car top”). In machine room-less elevator devices, the car top is positioned at the floor level of the top floor, and periodic inspections of the control panel and the like are performed from the car top. In cases where the lower part of the control panel is located below the car top and funds are available to inspect the lower part of the control panel, the height position of the car top must be adjusted by moving the car.

In addition, during periodic inspections, there are restrictions on the height dimension at which a worker can perform inspections without using a stepladder or the like (hereinafter referred to as “inspection-enabling height dimension”), and the areas of the control panel that need to be inspected during periodic inspections are preferably disposed within the inspection-enabling height dimension.

The object of the present invention is to provide an elevator device that allows easy inspection work such as the periodic inspections of a control panel.

### Solution to Problem

In order to solve the above problems, an elevator device of the present invention includes a car, a hoisting machine, and a control panel that controls operation. In the elevator device, the control panel has a regenerative resistance panel part, a main circuit panel part, a power receiving panel part, a signal panel part, and a battery panel part, the main circuit panel part and the power receiving panel part are arranged in parallel in a horizontal direction, and the regenerative resistance panel part, the main circuit panel part and power receiving panel part, the signal panel part, and the battery panel part are arranged in an order of, from top to bottom, the regenerative resistance panel part, the main circuit panel part and power receiving panel part, the signal panel part, and the battery panel part.

### Advantageous Effects of Invention

According to the present invention, it is possible to provide an elevator device that allows easy inspection work such as the periodic inspections of a control panel.

Objects, configurations, and effects other than the above will be apparent from the description of the following embodiments.

### BRIEF DESCRIPTION OF DRAWINGS

FIG. 1 is a cross-sectional view parallel to the vertical direction, illustrating the configuration of an elevator device according to an embodiment of the present invention.

FIG. 2 is a cross-sectional view parallel to the horizontal direction, illustrating the configuration of the elevator device according to the embodiment of the present invention.

FIG. 3 is an external view of a control panel of the elevator device according to the embodiment of the present invention.

FIG. 4 is a perspective view of a main circuit panel part and a power receiving panel part of the control panel illustrated in FIG. 3.

FIG. 5 illustrates the mounting structure of the control panel illustrated in FIG. 3.

FIG. 6 is a comparative diagram for explaining the features related to the placement of the control panel illustrated in FIG. 3 in comparison with a comparative example.

FIG. 7 illustrates an example of equipment placement in the elevator device according to the embodiment of the present invention.

FIG. 8 illustrates the construction of the control panel illustrated in FIG. 3.

FIG. 9 illustrates the periodic inspection of the control panel illustrated in FIG. 3.

### DESCRIPTION OF EMBODIMENTS

One embodiment of the invention will now be described with reference to the drawings.

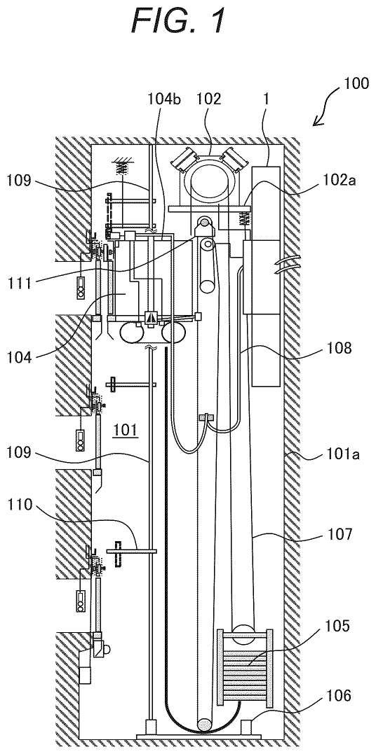

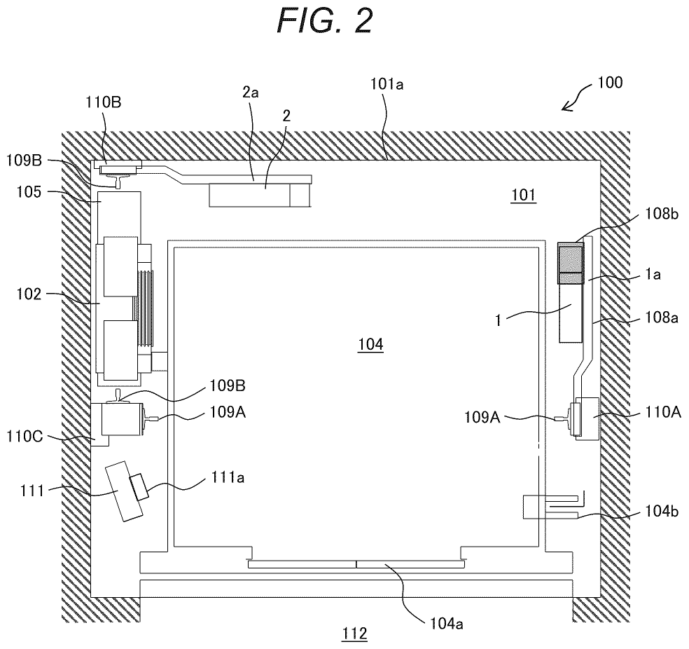

The overall configuration of an elevator device 100 will be outlined with reference to FIGS. 1 and 2. FIG. 1 is a cross-sectional view parallel to the vertical direction, illustrating the configuration of the elevator device 100 according to an embodiment of the present invention. FIG. 2 is a cross-sectional view parallel to the horizontal direction, illustrating the configuration of the elevator device 100 according to the embodiment of the present invention.

As illustrated in FIG. 1, the elevator device 100 includes: a car 104 and a counterweight 105 that move vertically within a hoistway 101; a hoisting machine 102 around which a main rope 107 connecting the car 104 and the counterweight 105 is wound; a guide rail 109 that is erected in the hoistway 101 and guides the vertical movement of the car 104 and the counterweight 105; a control panel 1 that controls the elevator device 100; and a governor 111 for detecting the elevating speed of the car 104.

The car 104 and the counterweight 105 are provided inside the hoistway 101 in a building, and are suspended in a well-bucket manner by the main rope 107. The car 104 is electrically connected to the control panel 1 by a tail cord 108, receives power supplied through the tail cord 108, and exchanges control signals and various signals with the control panel 1. A buffer 106 is disposed on the bottom surface of the hoistway 101 below the car 104 and the counterweight 105.

The hoisting machine 102 is supported by a machine beam 102a and is disposed at the top of the hoistway 101, and the control panel 1 is disposed in the vicinity of the hoisting machine 102. That is, the control panel 1 is also disposed at the top of the hoistway 101. In the present embodiment, an example in which the hoisting machine 102 and the control panel 1 are arranged at the top of the hoistway 101 is shown, but the positions of the hoisting machine 102 and the control panel 1 are not limited to the top of the hoistway 101. However, the control panel 1 of the present embodiment has an effective configuration for cases where the hoisting machine 102 and the control panel 1 are arranged at the top of the hoistway 101. The configuration of the control panel 1 will be described in detail later.

The guide rail 109 is fixed to an inner wall (hoistway wall) 101a of the hoistway 101 by rail brackets 110.

As illustrated in FIG. 2, a car door 104a is provided on the side surface of the car 104 facing an elevator hall 112, and a space for equipment, such as the hoisting machine 102 and the control panel 1, is provided between the side surfaces of the car 104, excluding the side surface thereof on which the car door 104a is provided, and the hoistway wall 101a. A PosiTector 104b for detecting the position of the car 104 is provided on the car 104 so as to protrude from one side surface of the car 104 toward the hoistway wall 101a.

The elevator device 100 according to the present embodiment is of the traction type, in which the hoisting machine 102 frictionally drives the main rope 107 to move the car 104 vertically along a car guide rail 109A and move the counterweight 105 vertically along a counterweight guide rail 109B.

The guide rail 109 is erected in the vertical direction along the hoistway wall 101a. The car guide rail 109A and the counterweight guide rail 109B are provided as the guide rail 109. The car guide rail 109A is a guide rail for the car 104 and has a pair of guide rails. The counterweight guide rail 109B is a guide rail for the counterweight 105 and has a pair of guide rails.

The pair of car guide rails 109A are arranged separately on the hoistway walls 101A on both the left and right side of the car 104 when viewed from the elevator hall 112 side. One of the pair of car guide rails 109A is fixed to the hoistway wall 101a by a common rail bracket 110C, and the other is fixed to the hoistway wall 101a by a car rail bracket 110A. The common rail bracket 110C is a rail bracket that is shared between the car guide rail 109A and the counterweight guide rail 109B. The car rail bracket 110A is a dedicated rail bracket, which is provided for the car guide rail 109A.

The pair of counterweight guide rails 109B are arranged in the space where the counterweight 105 is disposed. That is, the pair of counterweight guide rails 109B are arranged in the same space on either the left or right side of the car 104 when viewed from the elevator hall 112 side. One of the pair of counterweight guide rails 109B is fixed to the hoistway wall 101a by the common rail bracket 110C, and the other is fixed to the hoistway wall 101a by a counterweight rail bracket 110B. Note that in the present embodiment, the common rail bracket 110C is fixed to the hoistway wall 101a that faces the left side surface of the car 104, and the counterweight rail bracket 110B is fixed to the hoistway wall 101a that faces the back side of the car 104.

In the following description, the car guide rail 109A and the counterweight guide rail 109B will be simply referred to as the guide rail 109 without “car” and “counterweight” when there is no need to distinguish therebetween. In addition, the car rail bracket 110A, the counterweight rail bracket 110B, and the common rail bracket 110C will be simply referred to as the rail bracket 110 without “common”, “counterweight”, and “car”, when there is no need to distinguish therebetween.

The hoisting machine 102 is disposed in a space configured on the left side of the car 104 when viewed from the elevator hall 112 side. In the present embodiment, the governor 111 having a governor encoder 111a is disposed in a space on the same side as the hoisting machine 102. The hoisting machine 102 is fixed to the hoistway wall 101a by the machine beam 102a described in FIG. 1, but the machine beam 102a is provided so as to hang across the car guide rail 109A and the counterweight guide rail 109B, so that the hoisting machine 102 is fixed to the hoistway wall 101a via the car guide rail 109A and the counterweight guide rail 109B.

The control panel (first control panel) 1 is disposed in a space configured on the right side of the car 104 when viewed from the elevator hall 112 side. The control panel 1 is fixed to the hoistway wall 101a by a control panel bracket (first control panel bracket) 1a. In this case, the control panel bracket 1a is fixed to the car guide rail 109A, and the control panel 1 is fixed to the hoistway wall 101a via the car guide rail 109A. The tail cord 108 described in FIG. 1 is connected to the control panel 1, and a tail cord support 108b for supporting the tail cord 108 is provided near the control panel 1. The tail cord support 108b is fixed, by a tail cord support bracket 108a, to the car guide rail 109A to which the control panel bracket 1a is fixed.

The elevator device 100 according to the present embodiment includes the control panel 1 as a standard control panel, and includes a second control panel 2 in addition to the control panel (first control panel) 1. The second control panel 2 is fixed to the hoistway wall 101a by a second control panel bracket 2a. In this case, the control panel bracket 2a is fixed to the counterweight guide rail 109B, and the control panel 2 is fixed to the hoistway wall 101a via the counterweight guide rail 109B.

The second control panel (option panel) 2 implements control components required as customer optional functions in addition to the basic control functions of the elevator device 100. For this reason, the second control panel 2 may not be provided.

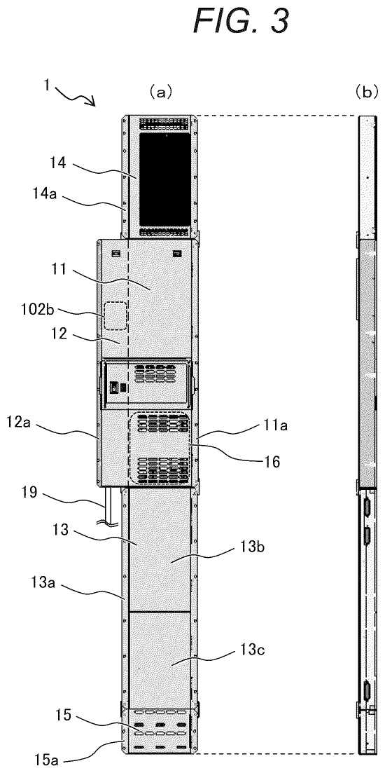

The configuration of the control panel 1 will be described with reference to FIG. 3. FIG. 3 is an external view of the control panel 1 of the elevator device 100 according to the embodiment of the present invention.

The control panel 1 has a main circuit panel part 11, a power receiving panel part 12, a signal panel part 13, a regenerative resistance panel part 14, and a battery panel part 15.

The main circuit panel part 11 is a control panel part that implements the main circuit elements, control boards, and the like for controlling the motor and brake of the hoisting machine 102. The main circuit panel part 11 includes a power supply panel part 16. The power supply panel part 16 is a control panel part that implements a control power source for the operational control of the elevator device 100, including the speed and position of the car 104.

The power receiving panel part 12 is a control panel part that implements a terminal block for receiving power supply for the hoisting machine 102, a circuit breaker and an electromagnetic contactor for turning on/off the power, a filter circuit for removing noise superimposed on the power lines, and the like.

The signal panel part 13 is a control panel part that implements a control board and the like for the operational control of the elevator device 100, including the speed and position of the car 104.

The regenerative resistance panel part 14 is a control panel part that implements a resistor for consuming, as thermal energy, the regenerative current generated when the elevator device 100 performs regenerative operation.

The battery panel part 15 is a control panel part that implements a battery power source to operate the car 104 to the nearest floor in the event of a power failure, or to perform a “brake release” to rescue passengers by moving the car 104 by the weight imbalance between the car 104 and the counterweight in the event of a failure of the elevator device 100, or the like.

In the control panel 1, the main circuit panel part 11 and the power receiving panel part 12 are arranged side by side in parallel. The regenerative resistance panel part 14 is disposed above the main circuit panel part 11 and the power receiving panel part 12, and the signal panel part 13 is disposed below the main circuit panel part 11 and the power receiving panel part 12. The battery panel part 15 is disposed below the signal panel part 13. That is, the control panel 1 has the regenerative resistance panel part 14, the main circuit panel part 11, the power receiving panel part 12, the signal panel part 13, and the battery panel part 15. The main circuit panel part 11 and the power receiving panel part 12 are arranged in parallel in the horizontal direction. The regenerative resistance panel part 14, the main circuit panel part 11 and power receiving panel part 12, the signal panel part 13, and the battery panel part 15 are arranged in the order of, from top to bottom, the regenerative resistance panel part 14, the main circuit panel part 11 and power receiving panel part 12, the signal panel part 13, and the battery panel part 15.

The regenerative resistance panel part 14 is a control panel part that easily generates heat, and by placing the regenerative resistance panel part 14 at the uppermost part among the main circuit panel part 11, the power receiving panel part 12, the signal panel part 13, the regenerative resistance panel part 14, and the battery panel part 15, the thermal influence on other control panel parts can be reduced.

In particular, in the control panel 1 of the present embodiment, the regenerative resistance panel part 14 is disposed above the main circuit panel part 11, and the signal panel part 13 is disposed below the main circuit panel part 11. That is, the regenerative resistance panel part 14, the main circuit panel part 11, the signal panel part 13, and the battery panel part 15 are aligned in a row (in series) in this order from the top to the bottom of the control panel 1. In other words, the regenerative resistance panel part 14, the main circuit panel part 11, the signal panel part 13, and the battery panel part 15 are aligned in a row (in series) in the vertical direction of the control panel 1. The power receiving panel part 12 is disposed so as to protrude horizontally (laterally) from the row of regenerative resistance panel part 14, the main circuit panel part 11, the signal panel part 13, and the battery panel part 15, which are aligned in series. Thus, a space is formed below the power receiving panel part 12.

Since the space is formed below the power receiving panel part 12, wiring can be easily routed by using this space to connect a wiring member to the power receiving panel part 12 from below the power receiving panel part 12. For example, the power receiving panel part 12 is connected to power supply lead-in wire 19 for the hoisting machine 102 through the space formed below the power receiving panel part 12, thereby facilitating the routing of the lead-in wire 19.

Conventionally, there have been cases where the functions of the power receiving part 12 are distributed between the main circuit panel part 11 and the signal panel part 13. In contrast, in the present embodiment, the functions of the power receiving part are integrated into the power receiving part 12. In addition, the power supply panel part 16 is disposed in the main circuit panel part 11. The power receiving panel part 12 is preferably disposed below the main circuit panel part 11. In this case, it is sufficient if the power supply panel part 16 is disposed closer to the lower end than the upper end of the main circuit panel part 11, but lower than the inspection-enabling height (1650 mm) as described below.

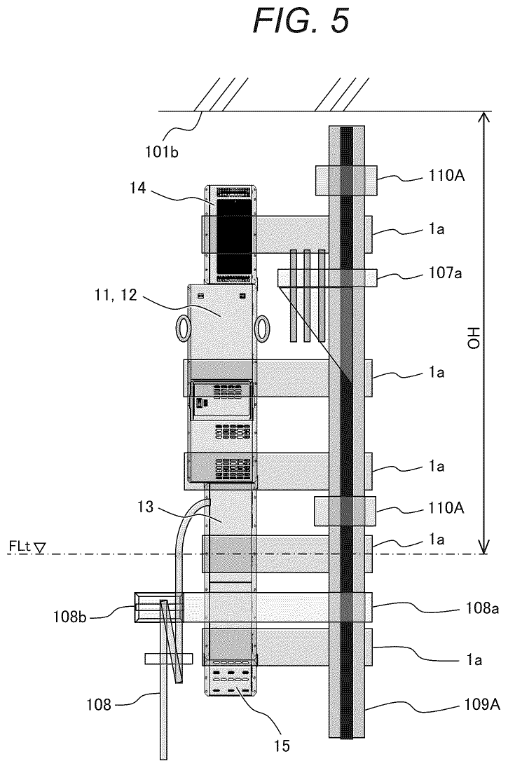

Fixing parts 14a, 11a, 12a, 13a, and 15a for fixing the control panel 1 to the control panel bracket 1a as illustrated in FIG. 5 are provided on the horizontal side edges of the control panel parts, namely the regenerative resistance panel part 14, the main circuit panel part 11, the power receiving panel part 12, the signal panel part 13, and the battery panel part 15. The fixing parts 14a, 11a, 12a, 13a, and 15a are configured as flanges (control panel flanges) protruding to the side of the control panel 1.

The fixing parts 14a, 13a, and 15a are provided on both side edges of the regenerative resistance panel part 14, the signal panel part 13, and the battery panel part 15. The fixing part 11a is provided on one side edge of the main circuit panel part 11 on the side opposite to the power receiving panel part 12 side. The fixing part 12a is provided on one side edge of the power receiving panel part 12 on the side opposite to the main circuit panel part 11.

Each of the control panel parts is provided with a lid, and the lid of the signal panel part 13 is divided into two lid parts 13b and 13c.

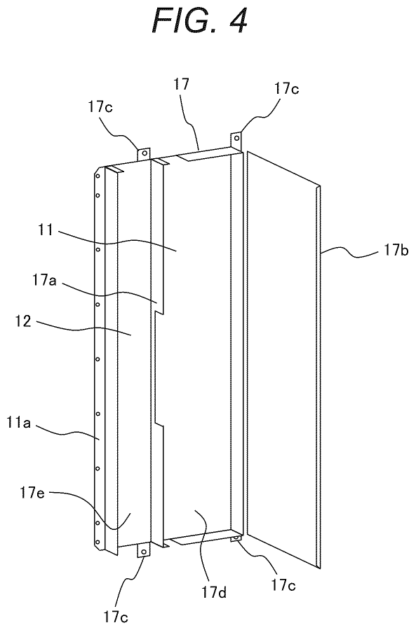

The configuration of the main circuit panel part 11 and the power receiving panel part 12 will be described with reference to FIG. 4. FIG. 4 is a perspective view of the main circuit panel part 11 and power receiving panel part 12 of the control panel 1 illustrated in FIG. 3.

The main circuit panel part 11 and the power receiving panel part 12 are housed within a single case 17 having two chambers 17d and 17e separated by a partition wall 17a, and are arranged separately in the two chambers 17d and 17e. Furthermore, the main circuit panel part 11 and the power receiving panel part 12 are covered with a single lid 17b. That is, the lid 17b is configured to cover both control panel parts of the main circuit panel part 11 and the power receiving panel part 12.

The main circuit panel part 11 and the power receiving panel part 12 are each provided with coupling parts 17c for coupling to the regenerative resistance panel part 14 and the signal panel part 13 arranged above and below. Such coupling parts 17c are also provided to other control panel parts 14a, 13a, and 15a, so that the control panel parts 14a, 11a, 12a, 13a, and 15a are configured so as to be interconnectable.

The mounting structure (fixing structure) of the control panel 1 will be described with reference to FIG. 5. FIG. 5 illustrates the mounting structure of the control panel 1 illustrated in FIG. 3.

In the present embodiment, the control panel 1 is fixed to the hoistway wall 101a by the car guide rail 109A fixed to the hoistway wall 101a by the car rail bracket 110A. For this purpose, the control panel bracket 1a is fixed to the car guide rail 109A, and the control panel 1 is fixed to the car guide rail 109A via the control panel bracket 1a.

The tail cord 108 from the car 104 is connected to the signal panel part 13 as illustrated in FIG. 5. The vicinity of one end of the tail cord 108 connected to the signal panel part 13 is supported by the tail cord support 108b fixed to the tail cord support bracket 108a. The tail cord support bracket 108a is fixed to the car guide rail 109A, and the tail cord support 108b is fixed to the hoistway wall 101a via the tail cord support bracket 108a and the car guide rail 109A.

In the control panel 1, the space formed below the power receiving panel part 12 is configured beside the signal panel part 13. This space allows the tail cord 108 connected to the signal panel part 13 to be disposed without protruding significantly to the side of the control panel 1.

In the present embodiment, the control panel 1 is disposed near the top floor. FLt in FIG. 5 indicates the floor level of a floor on which a car top 104b of the car 104 is positioned during the inspection of the control panel 1. In the present embodiment, FLt is the floor level of the top floor. In addition, OH represents the distance between the floor level FLt of the top floor and an upper end (ceiling surface) 101b of the hoistway 101, that is, the height dimension of the hoistway space formed above the floor level FLt of the top floor.

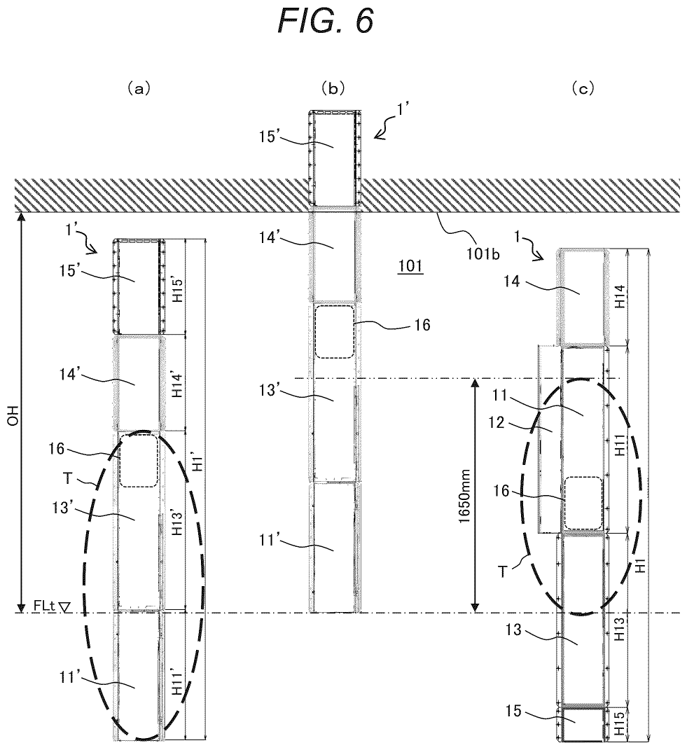

The placement of the control panel 1 will be described with reference to FIG. 6. FIG. 6 is a comparative diagram for explaining the features related to the placement of the control panel 1 illustrated in FIG. 3 in comparison with a comparative example.

FIGS. 6(a) and 6(b) illustrate a control panel 1′ in the comparative example. In the control panel 1′ of the comparative example, a battery panel part 15′, a regenerative resistance panel part 14′, a signal panel part 13′, and a main circuit panel part 11′ are arranged in order from the top. The power supply panel part 16 is included in the main circuit panel part 11 in the present embodiment, but is included in the signal panel part 13′ in the control panel 1′. Furthermore, in the control panel 1′, the power receiving part 12 of the present embodiment is arranged in a manner distributed between the main circuit panel part 11′ and the signal panel part 13′.

As illustrated in FIG. 6(a), if the control panel 1′ of the comparative example is to be disposed below the upper end 101b of the hoistway 101, the main circuit panel part 11′ is located lower than the floor level FLt of the top floor. The areas (hereinafter referred to as inspection area) of the control panel 1′ to be inspected during periodic inspections (legal inspections) stipulated by laws and regulations, such as insulation tests, are the signal panel part 13′ and the main circuit panel part 11′, and are indicated by the broken line T. In this case, the main circuit panel part 11′ within the inspection area T is located below FLt.

During the periodic inspection of the control panel 1, the car top 104b (see FIG. 1) of the car 104 is positioned at FLt, and a worker rides on the car top 104b to perform inspection work. In other words, the elevator device 100 according to the present embodiment is configured such that the control panel 1 and the hoisting machine 102 are disposed at the top of the hoistway 101, and the control panel 1 is inspected by the worker from the car top 104b while the car top 104b of the car 104 is positioned at the floor level FLt of the top floor.

In this case, if the control panel 1′ and FLt are in the positional relationship illustrated in FIG. 6(a), the worker cannot inspect the main circuit panel part 11′ from the car top 104b.

For this reason, in FIG. 6(a), it is necessary to move the car 104 to a height position that enables inspection of the inspection area of the main circuit panel part 11′, leading to complicated inspection work and a longer inspection time.

Therefore, FIG. 6(b) illustrates an example where the main circuit panel part 11′ is disposed above FLt so that the main circuit panel part 11′ can be inspected from the car top 104b. In FIG. 6(b), the upper part (battery panel part 15′) of the control panel 1′ is located above the upper end 101b of the hoistway 101, and the control panel 1′ does not fit in the top of the hoistway 101. In addition, in FIG. 6(b), the power supply panel part 16 included in the signal panel part 13′ is located beyond the height (set at 1650 mm in the present embodiment) that enables inspection from the car top 104b without the use of a stepladder or the like.

In the present embodiment, by using the control panel 1 with the main circuit panel part 11, the power receiving panel part 12, the signal panel part 13, the regenerative resistance panel part 14, and the battery panel part 15 arranged as described in FIG. 3, the inspection area T is located above the car top 104b and within the height range that enables inspection, as illustrated in FIG. 6(c).

As mentioned above, in the control panel 1′ of the comparative example, the power receiving part 12 of the present embodiment is disposed in a manner as to be distributed between the main circuit panel part 11′ and the signal panel part 13′, and the power supply panel part 16 is included in the signal panel part 13′. In the present embodiment, the power receiving part on the signal panel part 13′ side is integrated into the power receiving part 12 of the present embodiment, and the power supply panel part 16 is moved from the signal panel part 13′ to the main circuit panel part 11, thereby collecting the inspection area in the signal panel part 13 at the upper part of the signal panel part 13. In FIG. 6(c), although the lower part of the signal panel part 13 is located below FLt, this lower part is out of the scope of periodic inspection and does not affect the efficiency of work during periodic inspection.

In the main circuit panel part 11 of the present embodiment, the power receiving part on the main circuit panel part 11′ side is integrated into the power receiving part 12 of the present embodiment, and the power supply panel part 16 is disposed at the lower part of the main circuit panel part 11, thereby collecting the inspection area in the main circuit panel part 11 at the lower part of the main circuit panel part 11. In FIG. 6(c), the upper part of the main circuit panel part 11 is located above the inspection-enabling height (1650 mm), but this upper part is out of the scope of periodic inspection and does not affect the efficiency of work during periodic inspection.

As described above, in the present embodiment, the inspection area of the main circuit panel part 11, the power receiving panel part 12, and the signal panel part 13 can be inspected while the car top 101b of the car 104 is positioned at FLt. This can reduce the complexity of inspection work and improve workability.

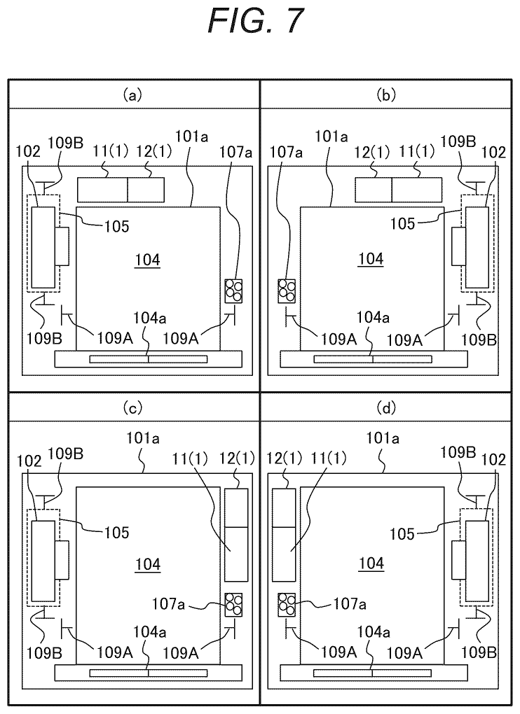

The placement of equipment such as the hoisting machine 102 and control panel 1 of the elevator device 100 will be described with reference to FIG. 7. FIG. 7 illustrates an example of equipment placement in the elevator device 100 according to the embodiment of the present invention. Note that in FIG. 3, the control panel 1 is illustrated with the main circuit panel part 11 and power receiving panel part 12 within the control panel 1.

FIG. 7(c) illustrates an example where the control panel 1, the hoisting machine 102, and the counterweight 105 are arranged as in FIG. 2. The car guide rail 109A and the counterweight guide rail 109B are also arranged in the same manner as in FIG. 2. Note that FIG. 7 illustrates a rope end 107a on the car 104 side. The rope end 107a is disposed on a side of the hoistway wall that faces, with the car 104 therebetween, the hoistway wall on the side on which the hoisting machine 102 and the counterweight 105 are disposed.

FIG. 7(a) illustrates an example of the modified placement of the control panel 1 from that in FIG. 2 (FIG. 7(c)). In this case, the control panel 1 is disposed in the space on the back side (opposite side to the car door 104a side) of the car 104. In this case, the control panel 1 is preferably disposed closer to the wall surface of the hoistway 101 on the side where the hoisting machine 102 is disposed, that is, the left-hand wall surface when viewed from the elevator hall 112 side. Thus, the wiring between the control panel 1 and the hoisting machine 102 can be shortened. Although not illustrated in FIG. 7(a), the control panel bracket 1a for fixing the control panel 1 is preferably fixed to the counterweight guide rail 109B disposed near the control panel 1. Note that the rope end 107a is disposed in the same manner as in FIG. 7(c).

FIG. 7(b) illustrates an example of the modified placement of the hoisting machine 102 and the counterweight 105 from that in FIG. 7(a). In this case, the hoisting machine 102 and the counterweight 105 are disposed closer to the right-hand hoistway wall when viewed from the elevator hall 112 side. In this case, the counterweight guide rail 109B is also disposed on the same side as the counterweight 105. The control panel 1 is also disposed closer to the right-hand hoistway wall when viewed from the elevator hall 112 side. Furthermore, the placement of the main circuit panel part 11 and the power receiving part 12 are interchanged from that in FIG. 7(a). Although not illustrated in FIG. 7(b), the placement of the common rail bracket 110C is also changed in accordance with the change in the placement of the counterweight guide rail 109B, so that the common rail bracket 110C is disposed on the same side as the counterweight 105. In this case, as in FIG. 7(a), the control panel bracket 1a for fixing the control panel 1 is preferably fixed to the counterweight guide rail 109B disposed near the control panel 1. Note that the rope end 107a is disposed on the hoistway wall side that faces the hoistway wall on the side on which the hoisting machine 102 and the counterweight 105 are disposed, and is disposed on the side opposite to the side on which the rope end 107a is disposed in FIG. 7(a).

FIG. 7(d) illustrates an example in which the control panel 1, the rope end 107a, the hoisting machine 102, and the counterweight 105 are interchanged from the arrangement in FIG. 7(c). In this case, the counterweight guide rail 109B is also disposed on the same side as the counterweight 105. In addition, although not illustrated in FIG. 7(d), the common rail bracket 110A is disposed on the same side as the counterweight 105. In the present embodiment, the control panel bracket 1a for fixing the control panel 1 is fixed to the car guide rail 109A disposed near the control panel 1 as in FIG. 7(c), but on a different side (opposite side) from in FIG. 7(c).

As illustrated in FIG. 7, the arrangement of the control panel 1, the hoisting machine 102, and the counterweight 105 can be changed from that in FIG. 2. By changing the arrangement of the control panel 1, the hoisting machine 102, and the counterweight 105, the arrangement of the car guide rail 109A, the counterweight guide rail 109B, the car rail bracket 110A, the counterweight rail bracket 110B, and the common rail bracket 110C is also changed as appropriate. Moreover, by changing the arrangement of the control panel 1, the car guide rail 109A, and the counterweight guide rail 109B, the guide rail 109 that fixes the control panel bracket 1a is also changed as appropriate.

In addition, although FIG. 7 illustrates the arrangement of the main circuit panel part 11 and the power receiving panel part 12, the arrangement of the main circuit panel part 11 and the power receiving panel part 12 is not limited to that in FIG. 7, and the positions of the main circuit panel part 11 and the power receiving panel part 12 in FIG. 7 may be interchanged.

Furthermore, since in the configurations in FIGS. 7(c) and 7(d), equipment such as the control panel 1 is not disposed on the back side of the car 104, the car door 104a can also be provided on the back side of the car 104.

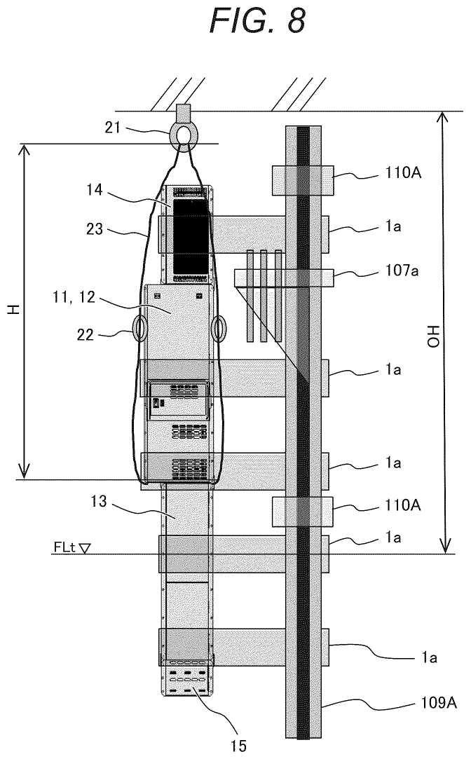

The construction of the control panel 1 in the elevator device 100 will be described with reference to FIG. 8. FIG. 8 illustrates the construction of the control panel 1 illustrated in FIG. 3.

When installing the control panel 1 in the hoistway 101, the regenerative resistance panel part 14, and the main circuit panel part 11 and power receiving panel part 12 are integrated into a single unit, which is lifted by a hanging hook 21 for work. The regenerative resistance panel part 14 can be coupled to the main circuit panel part 11 and the power receiving panel part 12 by the coupling parts 17c described in FIG. 4 to form a single unit. This allows the regenerative resistance panel part 14 to be lifted together with the main circuit panel part 11 and the power receiving panel part 12 by hanging the wire rope over the main circuit panel part 11. Even if sufficient clearance cannot be secured above the regenerative resistance panel part 14, a lifting allowance can be secured to lift the regenerative resistance panel part 14 together with the main circuit panel part 11 and the power receiving panel part 12.

The lifted regenerative resistance panel part 14, main circuit panel part 11, and power receiving panel part 12 are attached to the control panel bracket 1a. In this case, preferably, shackles to prevent collapse are attached to the upper parts of both edges (control panel flanges) 11a and 12a of the main circuit panel part 11 and the power receiving panel part 12, and the wire rope is wrapped around the shackles.

In FIG. 8, the signal panel part 13 and the battery panel part 15 may be attached to the control panel bracket 1a separately from the main circuit panel part 11 and the power receiving panel part 12, or may alternatively be integrated with the main circuit panel part 11 and the power receiving panel part 12 and attached to the control panel bracket 1a. That is, the signal panel part 13 and the battery panel part 15 may be separately attached to the control panel bracket 1a, or the signal panel part 13 and the battery panel part 15 may be integrated, and attached to the control panel bracket 1a separately from the main circuit panel part 11 and the power receiving panel part 12. Alternatively, the signal panel part 13, the battery panel part 15, the main circuit panel part 11, and the power receiving panel part 12 may be integrated and attached to the control panel bracket 1a. Note that in this case, the regenerative resistance panel part 14 is still integrated with the main circuit panel part 11 and the power receiving panel part 12, and attached to the control panel bracket 1a.

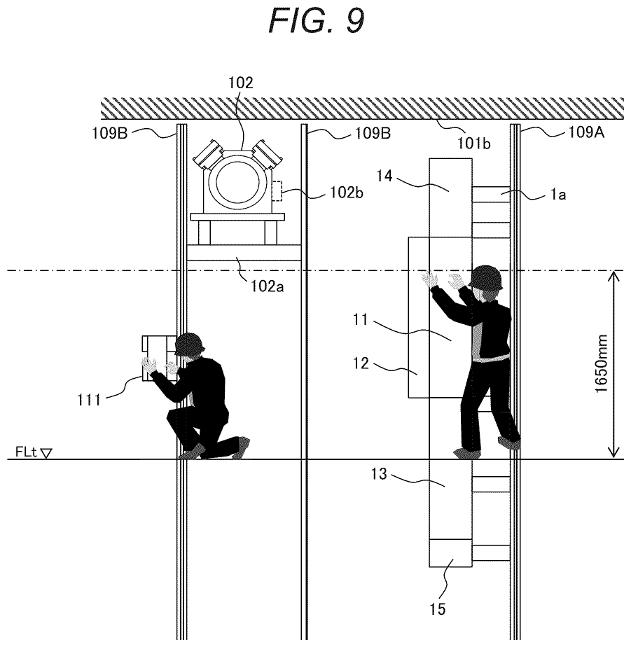

The periodic inspection of the control panel 1 will be described with reference to FIG. 9. FIG. 9 illustrates the periodic inspection of the control panel 1 illustrated in FIG. 3.

Since the drive devices, such as the hoisting machine 102 and the control panel 1, are arranged collectively at the top of the hoistway 1, it is difficult to secure a suitable location for each piece of equipment, and the mounting height of each piece of equipment is also restricted. In this situation, to improve maintainability, with the car top 101b of the car 104 positioned at FLt, the inspection area for periodic inspections in the control panel 1 is disposed within the range above FLt and up to the inspection-enabling height (1650 mm).

Furthermore, in the present embodiment, the governor 111 and the inspection area of the control panel 1 are arranged within the range above FLt and up to the inspection-enabling height (1650 mm). In other words, the elevator device 100 according to the present embodiment includes the governor 111 for detecting the elevating speed of the car 104, and the governor 111 is disposed below the upper end of the main circuit panel part 11 and the power receiving panel part 12. This allows maintenance and inspection work to be performed on the governor 111 and control panel 1 in parallel.

In addition, when maintaining the hoisting machine 102 from the car top 104b, it is necessary to shut off a power switch 102b on the hoisting machine 102. In the present embodiment, the power switch 102b is provided to the power receiving panel part 12, thereby eliminating the need for providing a new power switch box to the hoisting machine 102. Furthermore, the hoisting machine 102 is disposed at the top of the hoistway 101, especially near the upper end 101b, often higher than the inspection-enabling height (1650 mm). Even in such a case, the power switch 102b is provided to the power receiving panel part 12, thereby allowing the power switch 102b to be disposed within the range of the inspection-enabling height (1650 mm) and facilitating shutting off the power switch 102b of the hoisting machine 102.

In the present embodiment, the drive devices such as the hoisting machine 102 and the control panel 1 are arranged at the top of the hoistway 1. However, the advantageous effects of the above embodiment can also be effectively utilized in a configuration in which the drive devices such as the hoisting machine 102 and the control panel 1 are arranged at locations other than the top of the hoistway 1. For example, if the control panel 1 is disposed at the level of the second floor of the hoistway 101, FLt is set at the floor level of the second floor. In this case, depending on the size of the car 104, it may not be possible to lower the car top 104b to FLt. Even in such a case, by adopting the configuration of the control panel 1 of the present embodiment, the inspection area of the control panel 1 can be disposed within the range from the car top 104b of the car 104 lowered to its lowermost part to the inspection-enabling height (1650 mm).

It should be noted that the present invention is not limited to the embodiments described above, and includes various modification examples. For example, the embodiments described above have been described in detail to simply describe the present invention, and are not necessarily required to include all the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

### LIST OF REFERENCE SIGNS

11 main circuit panel part
12 power receiving panel part
13 signal panel part
14 regenerative resistance panel part
15 battery panel part
1 control panel
16 power supply panel part
17 case
17a partition wall
17b lid
17d, 17e two chambers separated by partition wall 17a
100 elevator device
101 hoistway
102 hoisting machine
104 car
104b car top of car 104
FLt floor level of floor (top floor) where car top 104b of car 104 is positioned

1. An elevator device comprising a car, a hoisting machine, and a control panel that controls operation, wherein
the control panel has a regenerative resistance panel part, a main circuit panel part, a power receiving panel part, a signal panel part, and a battery panel part,
the main circuit panel part and the power receiving panel part are arranged in parallel in a horizontal direction, and
the regenerative resistance panel part, the main circuit panel part and power receiving panel part, the signal panel part, and the battery panel part are arranged in an order of, from top to bottom, the regenerative resistance panel part, the main circuit panel part and power receiving panel part, the signal panel part, and the battery panel part.

2. The elevator device according to claim 1, wherein
the regenerative resistance panel part, the main circuit panel part, the signal panel part, and the battery panel part are arranged in series.

3. The elevator device according to claim 2, wherein
the power receiving panel part is disposed in such a manner as to protrude horizontally from a row of the regenerative resistance panel part, main circuit panel part, signal panel part, and battery panel part arranged in series.

4. The elevator device according to claim 3, wherein
the main circuit panel part is a control panel part that implements a control board for controlling the hoisting machine,
the power receiving panel part is a control panel part that implements a terminal block for receiving power supply of the hoisting machine,
the signal panel part is a control panel part that implements a control board for operational control of the elevator device,
the regenerative resistance panel part is a control panel part that implements a resistor for consuming, as thermal energy, a regenerative current generated when the elevator device performs regenerative operation, and
the battery panel part is a control panel part that implements a battery power source for operating the car to a nearest floor in an event of a power failure.

5. The elevator device according to claim 4, wherein
the main circuit panel part includes a power supply panel part that implements a control power source for the operational control of the elevator device.

6. The elevator device according to claim 5, wherein
the power supply panel part is disposed in the main circuit panel part so as to be closer to a lower end of the main circuit panel part than an upper end of the main circuit panel part.

7. The elevator device according to claim 6, wherein
the main circuit panel part and the power receiving panel part are housed within a single case having two chambers separated by a partition wall, are arranged separately in the two chambers, and are covered with a single lid.

8. The elevator device according to claim 7, wherein
a power supply lead-in wire for the hoisting machine is connected to the power receiving panel part through a space that is formed below the power receiving panel part.

9. The elevator device according to claim 8, wherein
the control panel and the hoisting machine are arranged at a top of a hoistway, and
an inspection of the control panel is performed such that a car top of the car is positioned at a floor level of a top floor, and a worker performs inspection from the car top.

10. The elevator device according to claim 9, further comprising
a governor for detecting an elevating speed of the car, wherein
the governor is disposed below upper ends of the main circuit panel part and power receiving panel part.
